(19) United States
(12) Patent Application Publication
(10) Pub. No.: US 2003/0074456 A1
(43) Pub. Date: Apr. 17, 2003

(54) System and a method relating to access control

(76) Inventors: Peter Yeung, Kista (SE); Henrik Sandstrom, Stockholm (SE)

Correspondence Address: ERICSSON INC., 6300 LEGACY DRIVE, M/S EVW2-C-2, PLANO, TX, 75024, US

(21) Appl. No.: 09/976,500

(22) Filed: Oct. 12, 2001

(51) Int. Cl. G06F 15/16

(52) U.S. Cl. 709/229; 709/219

(57) ABSTRACT

A system for end user control of the distribution and maintenance of end user personal profile data in a data communications system providing communication between applications comprising and/or communicating with service/information/content providers or holding means (DB) holding end user personal profile data. It comprises a personal profile protection network with at least one central protection server means, comprising or communicating with information holding means holding personal protection profile information, and a number of distributed access means, e.g. software modules. For each of said applications at least one access means is provided, and grant/reject of an access request for/to end user personal profile data by a requesting application is determined by the central protection server in communication with a requesting application and/or an information providing application. Translating means are provided for identity translation and the identity of a requesting application will be concealed for an information providing application, and vice versa.

### FIELD OF THE INVENTION

The present invention relates to a system allowing end user control of the distribution and maintenance of end user personal profile data, i.e. data within personal profiles, in a data communication system providing communication between applications, which comprise and/or communicate with service/information/content providers holding end user personal profile data. The invention also relates to a method of controlling access to personal profile data within a personal end user profile in a data communication system running a number of applications, comprising or communicating with information/content/service providers. The data communication system may be third party controlled, or alternatively it is not.

The invention also relates to a personal profile data control network for controlling the access to personal profile data.

### STATE OF THE ART

In the information society of today the personal profile data of end users will be more and more spread out at different locations e.g. on Internet, and with the fast development of global data communication networks, it gets possible to distribute data both via fixed and via wireless applications. Data will also be pushed out to an even higher extent than hitherto, e.g. by companies to other companies etc. The need for means to protect privacy therefore increases. For the individual end user it is exceedingly important that his personal information can be protected from uncontrolled distribution among end users, companies etc. At the same time as, for example, the number of services that can be provided to end users, over for example Internet, increases, it becomes more and more interesting for service and information providers to be able to obtain detailed information about users. This may be in conflict with the security aspect for the end users, as well as it of course also may be attractive for the end users, since they can also take advantage of personal information being spread out, and thereby obtain other useful or desired information etc. For statistical purposes it is interesting for e.g. companies to get information in order to become familiar with the needs for services, products etc. An end user may today have stored personal profile data of different kinds, at different locations, which contains various kinds of information about the user, such as name, address, particulars habits, hobbies, accounts, financial situation etc. Thus, it is exceedingly important for the service/content providers to know the characteristics of existing and potential customers to allow for targeted advertising etc., at the same time as it is also exceedingly important for the end user to be able to protect the personal profile data.

Thus there is an inherent conflict between different interests. Therefore laws and regulations have been created in an increasing number of countries, such as for example within the European Union, to restrict the accessibility to privacy information. Such laws and regulations often vary from one country to another, but generally they have in common that the consumer or the end user should have control over his or her profile, including conditions for its release.

Solutions have been suggested for systems for protecting user personal profile data acting as a kind of a safe or functioning as a profile repository. The profiles can, by replacement of the user identity, for example the mobile phone number, through a code, be stored such that there will be no connection to the user identity, throughout the network. Such a repository or storing means for user profiles can be arranged at different nodes within the network. One example is illustrated in FIG. 1, with a profile holding means provided between a portal and an advertising node. In FIG. 1 it is supposed that the personal profile has been transferred to the advertising node, with the user identity in the form of a mobile phone number (MSISDN) replaced by a code, which is totally unrelated to the phone number. The procedure will then be that the portal requests an advertisement for a user, e.g. with a phone number, 1. The profile holding means then forwards the request to the advertising node with the mobile phone number converted to a corresponding code, 2. The advertising node subsequently returns the advertisement to the personal profile holding means, 3, which subsequently returns the advertisement to the portal, 4. Such a system is for example known under the trademark Respect™ which is an e-business platform enabling privacy control, identity management and instant personalization for on-line transactions. The profile holding means is then represented by the Respect™ server which is a virtual infrastructure located at the mobile Internet provider.

However, there are several problems associated with systems as described above. One main issue is the transactional capacity of the profile protecting means. Normally the number of users that can be handled is limited, which results in serious problems for real time applications. With reference to the example given above, advertisements have to be served when an end user actually visits a particular page, or accesses a particular service, and many operations are time-critical. The time criticality is particularly important in wireless environments.

Another problem relates to the lack of generality when handling flows from several requesting nodes and from several information holding nodes. Another problem that is not solved in a general manner is really pertinent, and it is concerned with which nodes that should be allowed to request data from other nodes. Mapping between a code, for example known by the advertising node, and the phone number, as known by the portal, is actually performed in the profile holding means, also called a profile repository. It is not acceptable that for example the requesting portal asks the profile repository for the corresponding code, and then requests an advertisement for this code since, then the phone number and the code would be visible together.

### SUMMARY OF THE INVENTION

In order to solve these and other problems a system is needed through which end users are given the possibility of controlling which information, within a personal profile, that should be accessible by others, for example via applications etc, i.e. to be able to protect their private information at the same time as being given the opportunity/possibility of taking advantage of allowing access to others in order to get information etc. that is of interest for the specific end users, in a substantially automatic manner, and without expressively having to request such information.

It is also an object of the invention to provide a system which makes it possible to interconnect a large number of different information applications and service enablers or service/content/information providers while maintaining privacy and dynamical information routing. It is also an object to provide a system through which applications can be connected to the appropriate information/service/content providers or information holders without these applications having to know the address of the actual information holder or information provider. It is also an object to provide a system to facilitate for applications to find the information that is desired within the network, while still duly considering privacy requirements and restrictions. Further yet it is an object to make connection to applications as simple as possible, and without requiring different interface solutions for different kinds of providers, end users etc. It is also an object to find a solution allowing for locking/unlocking of private or personal information, particularly in a fast and easy manner, and in addition thereto to provide for a highly scalable system, as far as protection of data within personal profiles is concerned.

Still further it is an object to provide for easy and flexible control of private or personal information within fixed as well as within mobile data communication networks, such as for example Internet, Mobile Internet or private IP based Wide Area Networks (WAN), and to allow for a high scalability as far as equipment and networks are concerned, and also to support load sharing and redundancy solutions on network level.

A main object of the invention is to allow for anonymous IP addressing and anonymous provisioning of information. Still other objects are concerned with the provisioning of easy operation and maintenance, while still allowing for a privacy protection facility, and to reduce management requirements as much as possible, as far as privacy protection is concerned. It is also an object to suggest a solution that allows for, optimizes and facilitates, protection of personal information both as far as the end user is concerned, and as far as the operator and application provider are concerned. Particularly a solution is needed through which also problems associated with the use of discontinuous protocols or Application Programming Interfaces (API), such as for example HTTP (Hypertext Transfer Protocol) as opposed to for example E-mail services using continuous protocols like SMTP (Simple Mail Transfer Protocol), are concerned.

Moreover it is an object of the invention to provide a solution which both makes it easy for the end user to control the flow of personal information, e.g. between different companies, as well as makes it possible for for example companies or application providers handling personal, private information, to meet the requirements of laws and regulations for respecting privacy, and at the same time to be able to provide services based on personal information, for example position data. It is also an object to enable for example for an application provider to directly, in a digital way, get permission by the end user (indirectly), to use the requested information.

A personal profile data control network and a method respectively, of controlling access to personal data within personal end user profiles, are also needed, through which one or more of the above mentioned objects can be fulfilled.

Therefore a system as initially referred to is provided, which comprises a personal profile data protection network with at least one central protection server means, comprising or communicating with information holding means, e.g. a database, holding personal protection profile information, and a number of distributed access means, for example comprising software modules. For each one of said applications at least one access means is provided, and grant/reject of a request for access to end user personal profile data within a profile by a requesting application is determined by the central protection server in communication with the requesting application and/or the information providing application, or more specifically in communication with the corresponding access means thereof. Translating means, e.g. comprising encrypting means, are provided for identity translation and verification, and the identity of a requesting application will be concealed for an information providing application and vice versa. This means for example, that an application provider does not know where a requested piece of information is located and the operator of such a personal profile data control network or privacy information network, does not have to expose the addresses between application provider or information provider and requester. Particularly there is one access means for each application. Alternatively there may be a plurality or a cluster of access means for at least one application or for all applications, e.g. for redundancy reasons and/or to allow for load sharing at the site of the application. The server means at a site, particularly the protection profile holding means associated therewith, may also be redundant. Redundant server means (servers and/or profile holding means) may be provided; at a site or distributed.

Particularly the central server means only comprises personal protection profile data. This means that it does not contain any personal profile data as such, which is distributed throughout the system. The personal protection profile data comprises information about, for each end user of the system, which personal data within the end users personal profiles that should be accessible by which application, and/or vice versa, which data should not be accessible etc. In one implementation the personal protection profiles are assigned one of a given number of security levels, the lowest level e.g. indicating that all personal profile data should be inaccessible to every application, the highest level for example indicating that all personal profile data should be freely available, particularly with due regard to applicable laws and regulations. Of course a number of alternative ways of indicating which data should be accessible by whom etc. are possible, the main thing being that it is end user controlled and easily settable and update-able by the end user himself, so that end user in an uncomplicated manner is able to control who should get access to which personal data.

Particularly each application and the respective, thereto belonging, access means are interconnected over an interface, an Application Programmable Interface (API) based on a generic markup language. In a most advantageous implementation the generic markup language is XML (Extensible Markup Language).

In a preferred implementation access to requested end user personal profile data, i.e. data within an end user personal profile, is granted/rejected by the central server in communication with the requesting application. In an alternative implementation access to requested end user personal profile data is granted/rejected by the central server means in communication with the information providing application. In still another implementation, e.g. in case the access means of the requesting application cannot be trusted, access to requested data may be granted/rejected by the central server means in communication with both the requesting application and the information providing application. This, however, is somewhat inefficient in that additional encryption/decryption steps are required, as well as additional transmissions are necessitated. In a particular implementation (first) user identity translating or encrypting means are provided at least in the central server means. Further (second) identity translating means may alternatively also be provided in the access means of the requesting application and/or the information providing application. A first validation of the request is, according to the most preferred embodiment, wherein only the access means of the requesting application is in communication with the central server means, carried out in the access means of the requesting application. However, a further validation is also performed in the access means of the information providing application relating to its communication with a database holding the information being the object of the access request.

According to the invention particularly each user (application) of the system is assigned a unique DTD (Document Type Definition). Particularly is for each information requesting application and information providing application a specific agreement used, which in the following will be denoted a DTD agreement The agreement can be said to consist of rules controlling the communication between e.g. a requesting side and a providing side by defining which data that is allowed to be transferred between the two parts or sides, and the associated data to be transferred.

Between each pair of applications a general DTD agreement is given, and for each end user a user unique DTD agreement is given.

In a most preferred implementation a request for access to end user profile data is transported from the requesting application to its access means using RMI (Remote Method Invocation) whereby the request is transported as an XML transport object (in an XML node tree container) tagged with information about the requested end user personal profile data. Information between an access means and an application can alternatively be sent e.g. as an XML string. Instead of RMI may e.g. CCRBA™ be used. For communication between the access means of the requesting/information providing application respectively, and the central server means, is particularly the HTTPS protocol (Hypertext Transfer Protocol Secure) used. XML SOAP, CORBA™ etc. may alternatively be used.

In a preferred implementation the request is digitally signed by the access means of the requesting application (with a private key of the access means) and/or by the access means (a private key thereof) of the information providing application. Preferably it is also signed by the central server means using a private key thereof. In a most preferred implementation the request, when having been communicated to the central server, is validated by the access means of the requesting application. In an alternative implementation it is validated by the access means of the information providing application. In such an implementation, however, also the information providing application has to be involved, also when a request is rejected. It is clearly advantageous if in a network the information holding application does not have to be involved when requests are rejected, as in the first mentioned embodiment, thus reducing the load on the network as such, and on the information providing side in particular.

Digital signing at an access means (and in the central server means) may be optional, e.g. if the security is considered to be sufficient since the communication or exchange of information takes place within a network controlled by one and the same operator, or if the data need not be protected. Digital signing procedures are controlled by the central server means, and to which extent digital signing is to be implemented, and where, is thus end user controlled.

Particularly the central server means encrypts the user identity for the requested information used by the information providing application. In addition, or alternatively, in other, preferred, implementations, encryption of the user id used by the requesting application is performed.

In an advantageous implementation the system includes a cache memory associated with each application respectively, for temporarily holding information about access requests, such that a previously used session can be reused, at least for a given time period. It should be clear that each access means is associated with a database or similar, particularly a proprietary database holding agreement information and address information. The information providing application generally does not hold the information but fetches it from an information holder, e.g. a service/content/information provider or a database.

To solve one or more of the problems initially referred to the invention also suggests a personal profile data access control network for controlling the access to personal profile data. The network comprises at least one central protection server means, comprising or communicating with information holding means for holding personal protection profile information, and a number of distributed access means, e.g. software modules, at least one access means respectively interfacing each of a number of applications. The central protection server means comprises means for translating and verifying identities. A request for access to personal profile data by a requesting application is communicated to the access means of the requested application and it is granted/rejected by the central server means in communication with the access means of the requesting application and/or the established information providing application. The identity of the requesting application is concealed from the information providing application and vice versa. The interface between an application and the respective access means is based on a generic markup language, which advantageously is XML. Particularly the, with the central server means, associated information holding means contains personal protection profiles for each end user registered with the system, and the personal protection files are end user controlled. Preferably the central server means and the access means of the requesting/information providing applications digitally sign the requests for personal profile data with their respective private keys, and the digital signatures are verified by the control logic of the central server means and the access means respectively using the respective corresponding public key.

The invention also suggests a method of controlling access to personal data within personal end user profiles in a data communication network, running a number of applications, and comprising or communicating with information/content/service providers. The inventive method includes the steps of; providing an access request from a requesting application to an access means associated with the requesting application using a generic mark-up language, e.g. XML; forwarding the request from said access means to a central server means with information holding means holding personal protection profiles for the end users of the system; performing user identification translations/encryptions such that the user identification of the requesting application will be concealed for the information providing application and vice versa; establishing, by using the request and the personal protection profile, whether access is to be granted or rejected; if access to the requested personal profile data is to be granted, confirming to the access means of the requesting application that access is to be granted; validating the response to the request sent to the central server means; transmitting the translated (encrypted), preferably digitally signed, request to the access means of the information providing application.

The request of a requesting application particularly relates to getting access to data in (fetching data from or setting data in) a personal profile, and, the method particularly further may comprise the step of; using a third party controlled data communication network, e.g. Internet or another IP-based network, for communication between the requesting application and the information providing application, particularly using e.g. the HTTPS protocol.

Preferably the method includes the step of digitally signing the request in the access means of the requesting application before sending it to the central server means; performing an encryption of the user identity used by the information providing application in the central server means, signing the request in the central server means; validating the response to the request in the access means of the requested application; digitally signing the request in the access means; decrypting the user identity used by the information providing application in the access means of the information providing application, and digitally signing the request; transferring the request to the information providing application; accessing the requested data and signing the response in the information providing application; transmitting the requested data, if applicable, to the access means of the information providing application; digitally signing the requested information; sending the access granted information to the access means of the requesting application over the third party controlled data communication network using e.g. HTTPS; digitally signing the information message in the access means of the requesting application; sending the requested information data to the requesting application (e.g. using RMI). If data is to be set in a personal profile, it is instead the response to the request that is returned to the requesting application.

### BRIEF DESCRIPTION OF THE DRAWINGS

The invention will in the following be more thoroughly described, in a non-limiting manner, and with reference to the accompanying drawings, in which:

FIG. 1 is a schematical block diagram describing a state of the art system,

FIG. 2 very schematically illustrates the personal profile data protection network in communication with applications, providers etc.,

FIG. 3 is an illustration of a system allowing end user protection of personal profile data according to the invention,

FIG. 4 schematically illustrates a specific implementation of a system as in FIG. 3,

FIG. 5 schematically illustrates an alternative embodiment implementing a cache functionality,

FIG. 6 schematically illustrates a further alternative implementation of a system according to the invention,

FIG. 7 is a flow diagram describing one implementation of the concept when data within a personal profile is requested via a requesting application,

FIG. 8 is a simplified flow diagram illustrating an implementation with a cache, as described in FIG. 5,

FIG. 9 is a flow diagram illustrating one particular embodiment according to which the user identity should not be recognized by the requesting application,

FIG. 10 is a flow diagram describing an alternative implementation when the user identity should not be recognized by the requesting application,

FIG. 11 is a flow diagram schematically illustrating the central server means updating the distributed access means, and

FIG. 12 is a flow diagram describing end user setting of a personal protection profile in a central server means.

### DETAILED DESCRIPTION OF THE INVENTION

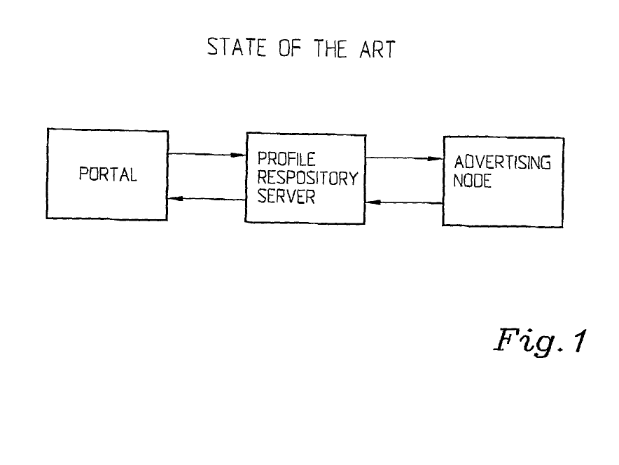

The state of the art solution as schematically indicated in FIG. 1 has already been discussed earlier in the application under the section “State of the art” and will therefore not be further described herein.

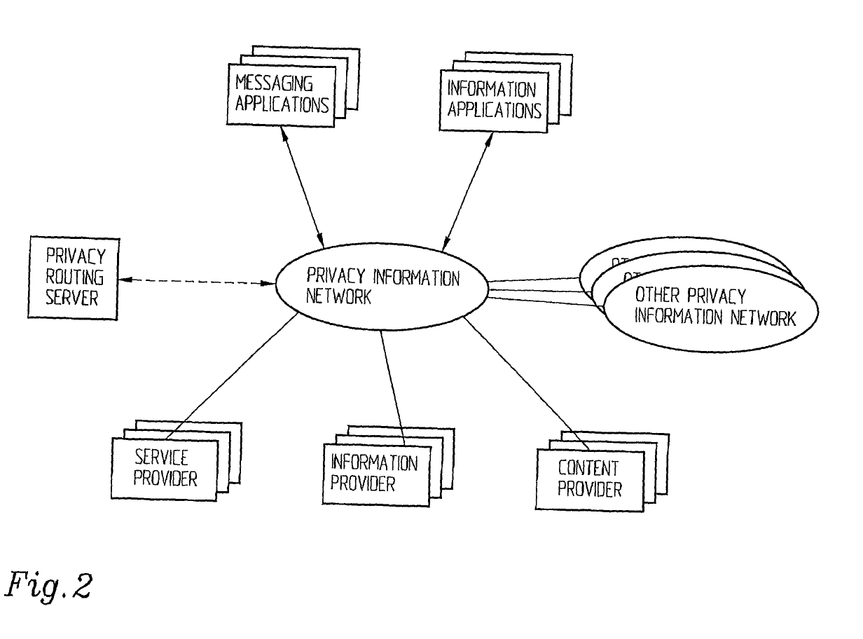

FIG. 2 is a schematical illustration of a personal profile protection network or privacy information network. According to the invention different information applications can be connected with several service/information/content providers including privacy protection and dynamic information routing. Through the personal profile protection network applications, information providers, service providers, content providers and other privacy information networks are interconnected, making it possible to connect in any appropriate manner requesting applications with information providing applications or providers, without the applications having to know the addresses of each other. Large personal profile protection networks can be built on for example Internet, Mobile Internet or any private IP based WAN (Wide Area Network).

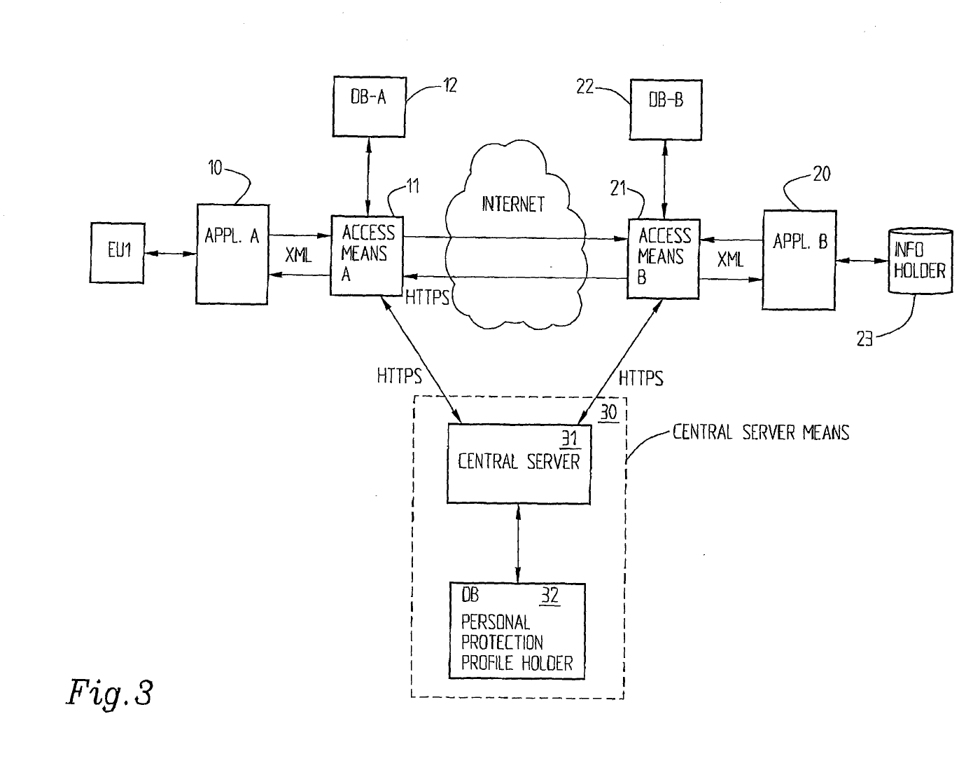

FIG. 3 shows one example of a system according to the invention. The system includes an application A 10 with access means A 11 and an application B 20 with access means B 21. Each access means 11, 21 communicates with a database, DBA 12 and DBB 22 respectively. The access means 11, 21 form part of the personal profile data protection network and communicate with a central server means 30 comprising a central server 31 and a database 32 holding personal protection profile information.

The access means interfacing an application may comprise one single, or two, or more access means, or even a cluster of access means, for example depending on redundancy and load sharing requirements on the application site.

The central server means handles or controls the information routing and personal profile data locking/unlocking. Of course a personal profile data control network may comprise more than one central server means and a plurality of (singular or multiple) access means, but for reasons of clarity only two access means, one for each application, and one central server means are illustrated in the figure. For redundancy there may also, or alternatively, be more than one central server at a site, or at multiple sites. There may also be at least duplicate information holding means associated with a central server.

It is here supposed that application A 10 is the requesting application, here communicating with end user EU 1 and it may for example request access to personal profile data located anywhere in the network, either for the purpose of fetching the data, or for the purpose of setting new data in the personal profile. Both getting and setting (pull and push) of data is covered by the inventive concept, and the functioning is in principle similar.

It is here further supposed that the application B 20 is an information providing application that finds the data in information holding database 23.

In the databases 12,22 of the access means 11,21, information is contained about which is the central server that handles the respective agreements between information requesting and information providing applications, and the databases 12,22 do also contain the address, e.g. IP number based .URL:s (Uniform Resource Locator) of the (appropriate) central server means.

The access means A 11 does not know where to send the request received from application A 10. Access means A 11 is interfaced with application A 10 over an XML object based API (Application Programming Interface). Preferably each application uses RMI (Remote Method Invocation) for communication with its respective access means. For communication between an access means and the central server means e.g. HTTPS is used. Access means belonging to different applications also communicate using HTTPS e.g. over Internet or another IP based communication network.

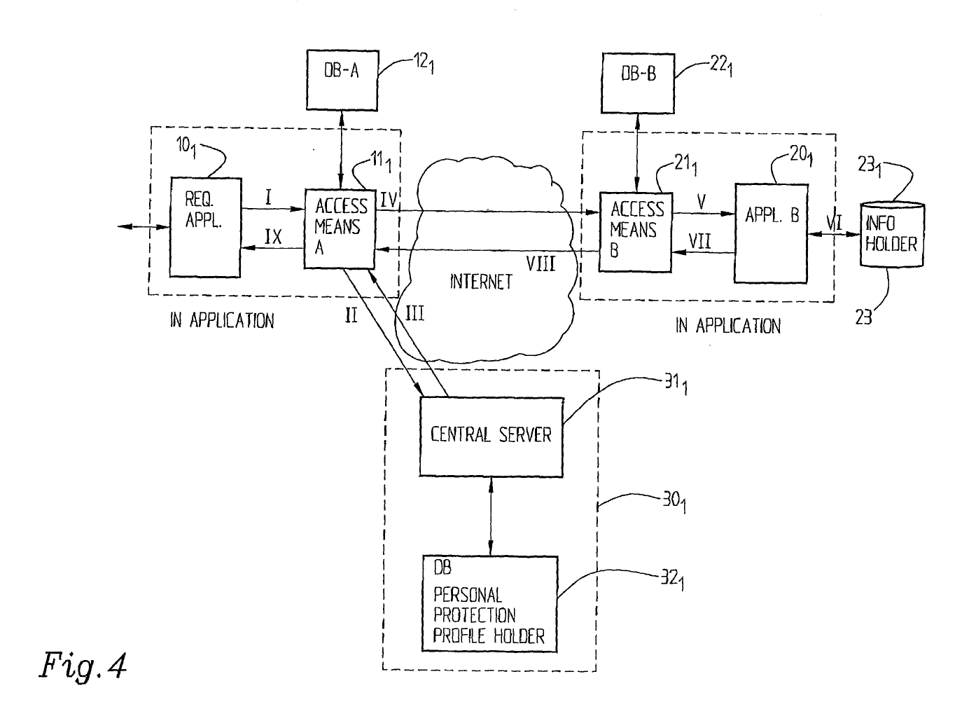

This figure does not show in detail how the communication is carried out, but it illustrates a general system that can be used in different ways. In one implementation, however, (cf. also FIG. 4) application A 10 sends a request for personal profile data to its access means 11 using XML objects or text. Access means 11 does not know what to do with the request and questions its database DB A 12 to find out the address of the central server means to which the request should be forwarded. Via HTTPS the request is forwarded to the central server 31 which establishes, using database 32 containing personal protection profiles whether the access request should be allowed or not, i.e. whether the data may be accessed or not by the particular requesting application.

An indication of a rejection or a grant of the access is returned to access means A 11, which in case of grant, then uses HTTPS for communication with access means B 21, which in turn verifies and requests application B 20 to access to the data, which in turn accesses the data in information holder 23. Subsequently information is returned to application A 10 via access means B 21 of application B 20, over Internet to access means A 11. In access means B 21 may optionally a validation of returned data from application B 20 be performed.

The communication with the central server means may alternatively be performed exclusively via access means B 21. It should be clear that each access means can be used in a similar manner independently of whether the interfaced application acts as an information requesting application or as an information providing application.

The used XML object based API can easily be interfaced without requiring protocol conversions, and it is based on information level communication which does not expose the implementational details between involved elements. Every new type of information service that is needed only needs a DTD agreement for the information that has to be transported, which provides a standard way to allow for integration between information products, having as a result that different applications do not have to implement new APIs for different types or formats of information to be transferred, instead the (DTD) agreement is changed or replaced.

A fundamental characteristic of the system according to the invention is that access rights to personal information are administrated by the end user at a central location, i.e. at the central server means, whereas the personal profile data, i.e. the information as such, is distributed throughout the communication system or communication network on different sources. One reason therefore is that it is not really plausible to keep all personal information at one and the same location. Another reason is that personal data can be highly dynamic, an example thereon is the position of a user in a mobile network. Another example relates to the balances of user's check accounts which also vary rapidly. It also facilitates for an end user to protect the personal data in an environment with a large number of information requesters and a large number of information providers, and therefore it has been found that it is extremely advantageous to provide the end user with a central facility where the end user can lock/unlock, i.e. customize access to, personal information from different providers and to different information requesters.

According to the invention an information requesting application does not know the identity of an information providing application or information holding means and vice versa. The only way to send personal profile data from an information holding side to an information requesting side is by translating the identities, preferably in the central server. This means that there will be no connection between personal information from different locations without going through the user controlled central server means. By having the personal profile data or information spread out at different locations, or at the same location but unrelated, with different user identities, the result will be that mining of the end user privacy is not possible. The central server means only holds information about which personal data that is locked and unlocked respectively, it does not “own” the actual information.

With reference to FIG. 4 an advantageous implementation will be more thoroughly described. It is supposed that an information requesting application 10₁ wants to pull (get) information from an information providing application 20₁ without knowing where to find the information itself. In this implementation it is supposed that communication with the central server means is provided by the access means 11₁ interfacing the requesting application 10₁. The advantage of such an implementation is that a fast response is obtained from the privacy network, i.e. from the central server means 30₁, as to whether the requested transaction is possible, without even having to involve the access means 21₁, of the information providing application 20₁ (or the information providing application itself). The load resulting from rejected transactions on the access means 21₁ on the information providing side will thus be considerably reduced as compared to a case when the providing side is involved at an early stage.

Thus, when the information requesting application 10₁ wants to set information in, or get information from, an information provider, or holder, the requesting application 10₁ makes a request towards “its” access means 11₁. The requesting application does not know the address to the information provider. It is further supposed that access means 11₁ holds a public key and a private key. The private key PKI (Private Key Infrastructure) of a node may e.g. be stored as a key object, e.g. a secured object file.

In a particular implementation the request is sent over RMI, and it preferably contains:

the user identity (ID) associated with the request and used by the requesting application,

a DTD Agreement Version,

a DTD Agreement ID,

a Transaction ID,

an ID of the Requesting Application,

a Gateway ID, and

an XML Node Tree Container.

The XML Node Tree Container contains an XML node tree tagged with which information the requesting application wants to get or in which personal data he wants to set data, update data etc. The tagged XML node tree may e.g. be described as a form, an XML node tree form.

The XML Node Tree Container is an object for transportation of the XML Node Tree between the requesting application and its access means 11₁. I indicates a request from the requesting application 10₁ to the access means 11₁. Access means 11₁ finds the general DTD agreement file, the general XSLT file, the Public Key of the central server means, DNS (Domain Name Server) names and IP addresses (one or more IP number based URLs in order from the main central server means for the DTD agreement ID, in case there are more than one central server means).

In one implementation it may be an option to look up a specific central server means ID, if it is specified in the database (DB-A 12) with a specific central server means public key. This may be used when the central server means is not one in the cluster with the same public key, but e.g. one which uses the same domain name. The relevant information for central server means ID, agreement information etc. is fetched by the access means 11₁ from the associated database 12₁.

The access means 11₁ of the requesting application 10₁ then sends the request on, II, to the central server means 30₁ to find the DTD agreement. Particularly HTTPS is used, and the request particularly comprises:

the identity of the requesting application access means 11₁,

the digital signature of the requesting application access means with its private key,

the end user ID used by the requesting application 10₁,

the DTD agreement version,

the DTD agreement ID,

the Transaction ID,

the Gateway ID, and

the requesting application ID.

A response is then awaited and expected from the central server means 30₁. In the meantime, while awaiting the response, the requesting application access means 11₁ validates the XML node tree with the general DTD file for the DTD agreement ID. This constitutes a basic validation and it is done the first time the DTD agreement ID and version are used, from the time that the server is up and running in order to limit the load on the requesting application access means 11₁.

The central server 31₁ comprising control logic, checks the authentication of the request with the identity of the access means, the IP address (optionally) and the digital signature against the public key of the access means 11₁. The requesting application user ID and the DTD agreement ID are then mapped onto the information providing application user ID. It should be noted that the user identity used by a requesting application can be, or normally is, different from the user identity used by an information providing application. Further, the user identification used by an application is not the identification of the application.

The information providing application 20₁ user ID is encrypted with date/time using the public key of the access means 21₁ of the information providing application 20₁, such that it only can be read and understood by the information providing application access means 21₁. The encrypted pattern should be different every time the access means 11₁ of the requesting application 10₁ makes a request. The central server 31₁ gets a digital signature for the user unique DTD file from the database holding protection profile information 32₁, signed with the private key of the central server means 31₁. To obtain a good performance, all DTD-files are preferably signed in advance. “Out of band” information elements are also signed. (By “out of band” information is here meant the systems level communication layer, e.g. including control information for the access means. This can e.g. be implemented as HTTP POST in the forward direction and as a cookie in the backward direction.)

The central server means 31₁ then, III, returns messages to the requesting application access means 11₁ containing the user unique DTD file as in band information. (By “in band” is here meant information at the application data communication layer, e.g. at XML document level.) The central server means 31₁ also returns “out of band” information such as:

the digital signature of the user unique DTD file,

the digital signature of the central server means “out of band” information,

the identity of the central server means,

the encrypted user ID, i.e. the information providing application user ID,

time to live,

inactivity time,

response time,

the domain name of the access means 21₁ of the information providing application 20₁,

its IP address, and

the public keys of the respective access means 11₁, 21₁.

If the DTD agreement ID version from the central server 31₁ does not correspond to the DTD agreement ID version from the requesting application 10₁, an error notification will result and be logged. The transaction ID from the requesting application 10₁ (via its access means 11₁), the user ID of the requesting application, and the encrypted user ID of the information providing application will be logged in the central server means 30₁.

In the access means 11₁ of the requesting application 10₁, the digital signature of the central server means 31₁, with its public key, is authenticated. The requesting access means 11₁ will perform a transformation of the XML node tree to an XML transport file with the general XSLT file (the XSLT file for that particular DTD agreement ID) (XSL Transformation; XSL is e.g. described in XSL Transformations (XSLT) Version 1.0, W3C Rec. dated Nov. 10, 1999 and XSL Transformations (XSLT) Version 1.1 W3C Working draft, Dec. 12, 2000, which documents herewith are incorporated herein by reference).

The requesting application access means 11₁ validates the received user unique DTD file against the XML transport file. Next the XML-file will be signed. If there is a request for something, via an XML attribute, for which access is not allowed, an error message will be returned to the requesting application 10₁ by one of the access means.

If however the validation can be completed without errors, the requesting application access means 11₁ sends, to the access means 21 of the information providing application, IV,:

the XML transport file (as in band information) and out of band information, e.g. in the form of a Cookie, i.e. the digital signature for the XML transport file with the private key of the access means 11₁,

the digital signature of the out of band information from the central server means 30₁, which means the server ID,

encrypted user ID (user ID of the information providing application),

time to live,

inactivity time,

response time,

the validation of the information providing side,

DTD agreement ID and DTD agreement ID version, and

the public keys of respective access means 11₁, 21₁.

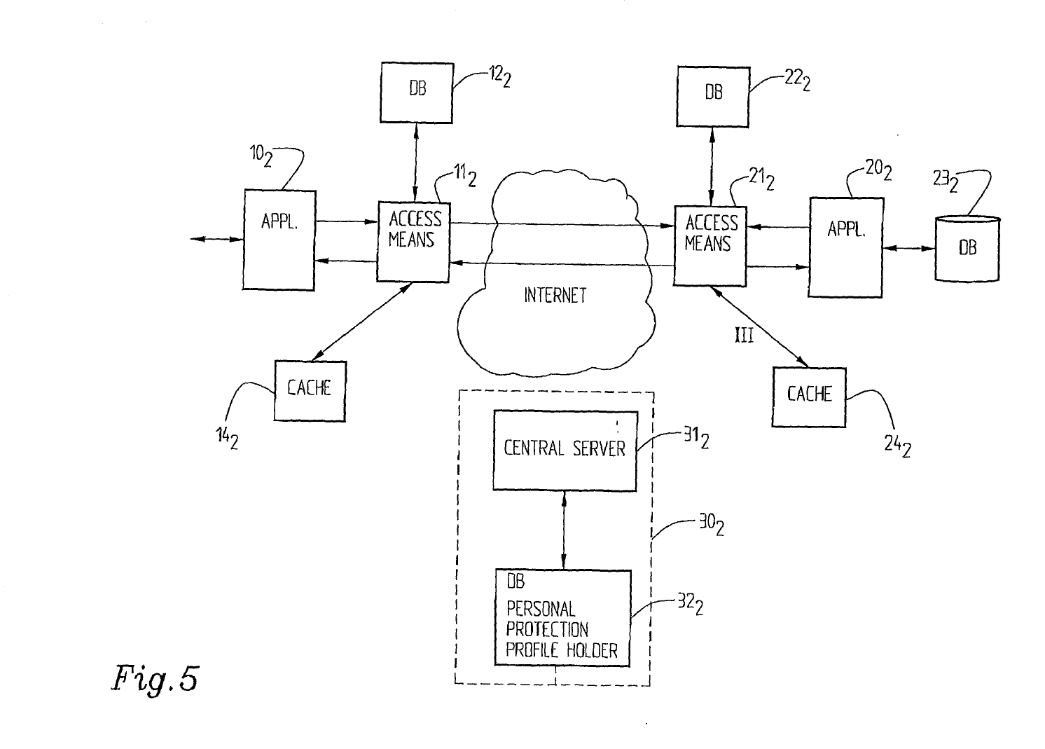

In one implementation, particularly discussed with reference to FIG. 5, implementing caches in association with the respective access means, a session ID of the information providing side can be included as well. If, however, there is no session, the session ID will be zero.

The requesting application access means 11₁ here uses HTTPS for communication with the access means of the information providing side, (IV). If the DTD agreement version differs from the requesting application DTD agreement ID, a rejection is returned to the requesting application 10₁ by which the DTD agreement is supported. If the out of band information parameter relating to validation with the information providing side, from the central server 31₁ is set, then the requesting application access means 11₁ will add the user unique DTD file into the XML transport file.

If the requesting application access means 11₁ does not receive any response from the access means 21₁ of the information providing application within a predetermined time interval, out of band information from the central server, the requesting application access means 11₁ will disconnect the (TCP; Transmission Control Protocol) connection. It will also empty the session data after a predetermined number of attempts to get a response from one and the same access means on the information providing side. Possibly it will be done after one or more attempts on other access means of the information providing application, in case there is for example a cluster, multiple access means or duplicated access means or similar.

When the information providing application access means 21₁ receives the request, (IV), it retrieves, using the DTD agreement ID and its version:

the public key of the central server,

the ID of the central server and the general DTD agreement file, and,

the general XSLT file for the particular DTD agreement from its database 22₁.

The digital signature by the requesting side access means 11₁ of the XML transport file is verified against the public key of the requesting side access means from out of band information, DTD agreement ID, DTD agreement ID version, central server ID and central server 31₁ signature of the out of band information against the database 22₁. The information providing side user ID is decrypted. If the session on the providing side is still active, or ongoing as given by the out of band information, then there is no need for a decryption of the information providing side user ID, since the session is still alive in a decrypted form. The XML file is then parsed to an XML node tree and, here, information providing application 20₁ is invoked by sending the XML node tree container, a generated transaction ID, ID and version of DTD agreement over RMI. Every new DTD agreement ID and version is validated by the information providing side access means 21₁ against the general DTD agreement file each time the server is activated.

For the particular session, and in communication with the information providing application 20₁, the access means 21₁ will use the out of band parameter time to live (or inactivity time), V.

The information providing application 20₁ then checks what information should be get or set from the XML node tree form and sends a response, VII, to the corresponding access means 21₁ containing an XML node tree filled with the requested information, and also information about completion status. The XML node tree is returned from the information providing application 20₁, after fetching information, VI, from information holder 23, back to the respective access means 21₁ in an XML node tree container.

The information providing application access means 21₁ then transforms the XML node tree received from the application 20₁ to an XML transport file with the general XSLT file for that DTD agreement ID. An answer is then sent over HTTPS with the new XML transport return file to the access means 11₁ of the requesting application 10₁, VIII. If the XML transport file received at the requesting side contains a user unique DTD, and the out of band parameter relating to validation on the providing side is set to “yes”, the access means 21₁ on the providing side may perform a validation.

If, however, there was no response from the information providing application, i.e. if the defined time period, within which a response should be provided, has lapsed, corresponding to out of band information from the central server, the access means 21₁ on the information providing side sends a reasoned notification back to the access means 11₁ of the requesting side. A reasoned notification or an error message, either from the access means on the providing side or from the information providing application, should be sent as out of band information back towards the access means of the requesting application as a cookie with data from the access means on the information providing side. For a successful request, there will be no error message in the cookie.

If the requesting side access means 11₁ disconnects the TCP connection to the information providing side access means 21₁, it will have as a result that the providing side access means 21₁ disconnects the connection with the information providing application 20₁ in a controlled manner.

As the access means 11₁ on the requesting side receives the XML transport file, it parses it to an XML node tree. It returns the XML node tree in the XML node tree container with session ID and possible error messages, if there are any, to the requesting application 10₁, IX. If a cache is implemented, as schematically illustrated in FIG. 5, a session or object data can be stored into said cache for a given time period, and the XML node tree container with the session ID can be reused for the subsequent request for the same session as long as the relevant information is still stored in the cache.

As already has been indicated above, for in band information an XML file is used between the respective access means, and DTD files are sent from the central server means towards the respective access means over HTTP with SSL (Socket Secure Layer).

For out of band information from the respective access means towards the central server means 31₁ preferably HTTP (SSL) body is used, and for an out of band information response from the central server means, preferably a cookie, or some other information field, is used.

In a particular implementation all transaction ID:s from the requesting application with providing side user ID are logged in a log file in the access means on the requesting side. Preferably the logging can be turned on or off. Similarly all transaction ID:s which are generated by the access means on the providing side with encrypted user ID:s of the providing side can be logged in the access means on the providing side. Preferably also this logging is can be turned on or off.

An access means is according to the invention able to act both as an access means for a requesting side and for an information providing side, i.e. the access means are similar and provide the relevant functionality in acting in the requesting procedures as well as in the providing procedures.

In a particular embodiment the requested information may comprise one or more binary attachments.

In one implementation an attached password may optionally be enclosed which is used with the providing side user identification to allow access by any user providing this password.

FIG. 5 illustrates an implementation with caching of sessions. The functioning is in principle similar to that described with reference to FIG. 4. It is illustrated how the requesting application 10₂ communicates with the requesting side access means 11₂, which fetches information from, or accesses information in, an associated database 12₂ as described above, and session information in cache 14₂. In a similar manner, at the information providing side, an application 20₂ communicates with access means 21₂ associated with a database 22₂ and a cache 24₂. The figure also illustrates the central server means 30₂, i.e. central server 31₂ and protection profile holding database 32₂.

It is here supposed that the requesting application 10₂ makes a request for a user in a non-timed out session. Steps II, III, (cf. FIG. 4) are then omitted, and the access means 21₂ of the providing side continues to request the information from the information providing application 20₂. At the requesting side, the returned XML node tree container from access means 11₂ can be reused for the subsequent request for the same session. Since the XML node tree container contains a session ID, the access means 11₂ on the requesting side will reuse the same session. The returned XML node tree container advantageously also contains status messages and returned XML node tree. If there are more than one access means, e.g. for reasons of redundancy, and an application wants to reuse existing session data from an earlier invocation by the application, the application generally has to access the same access means within the cluster, using the same session ID as it used at the preceding invocation.

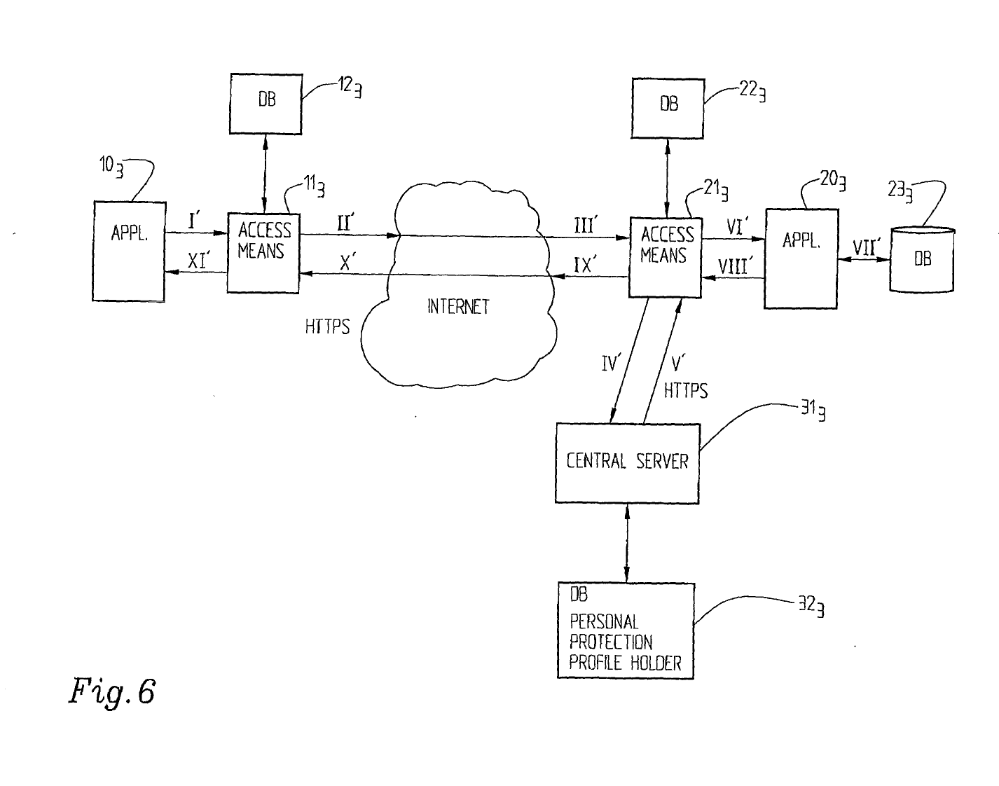

With reference to FIG. 6 an alternative implementation is illustrated in which the information providing side handles the communication, via its access means 21₃, with the central server means, i.e. the central server 31₃. Such an implementation will however produce an increased load on the information providing side in case of rejected requests, as compared to the embodiments discussed above. (Also here may of course reuse of session ID be implemented.)

It is supposed that requesting application 10₃ makes a request for user information to its access means 11₃, I′. The access means 11₃ encrypts the user ID used by the requesting application and a random number with the private key of the central server 31₃ to assure that it will only be understandable to the central server 31₃. Requesting side access means 11₃ then signs the user ID and the XML node tree, as discussed above with reference to FIG. 4, with the private key of the access means. The request is then sent to the access means 21₃ of the providing side over Internet (or other IP-network), HTTPS, II′, III′. Subsequently the request is received on the providing side access means 21₃, which signs the request and sends it to the central server 31₃, IV′, for decryption.

The central server 31₃ in communication with the database holding personal protection profiles 32₃, checks the signatures of the respective access means and decrypts the user ID. The providing side user ID is looked up and it is established to which extent the requested access is allowable, i.e. user information can be accessed by the requesting application according to the personal protection profile of the user stored in the database. The request is updated with the access rights, e.g. request granted (e.g. to limited extent) or denied etc., and the response is returned to the providing side access means 21₃, V′, using HTTPS. It is here, however, supposed that the access request was granted.

The providing side access means 21₃ then sends a query, VI′, to the information providing application 20₃ for the information that was authorized by the central server 31₃. In communication with the database information holder, VII′, the information providing application 20₃ returns the information to the access means 21₃, VIII′. The providing side access means 21₃ then returns the authorized information towards the requesting side using the HTTPS session, IX′, X′. The authorized information is then received by the requesting side access means 11₃, which returns the information requested by the requesting application that was authorized, XI′. Instead of fetching information for example from the database or information holder DB 23₃, data can also be set in for example DB 23₃, the functioning will in principle be the same, but information would then be provided to the “providing” application instead of requested therefrom.

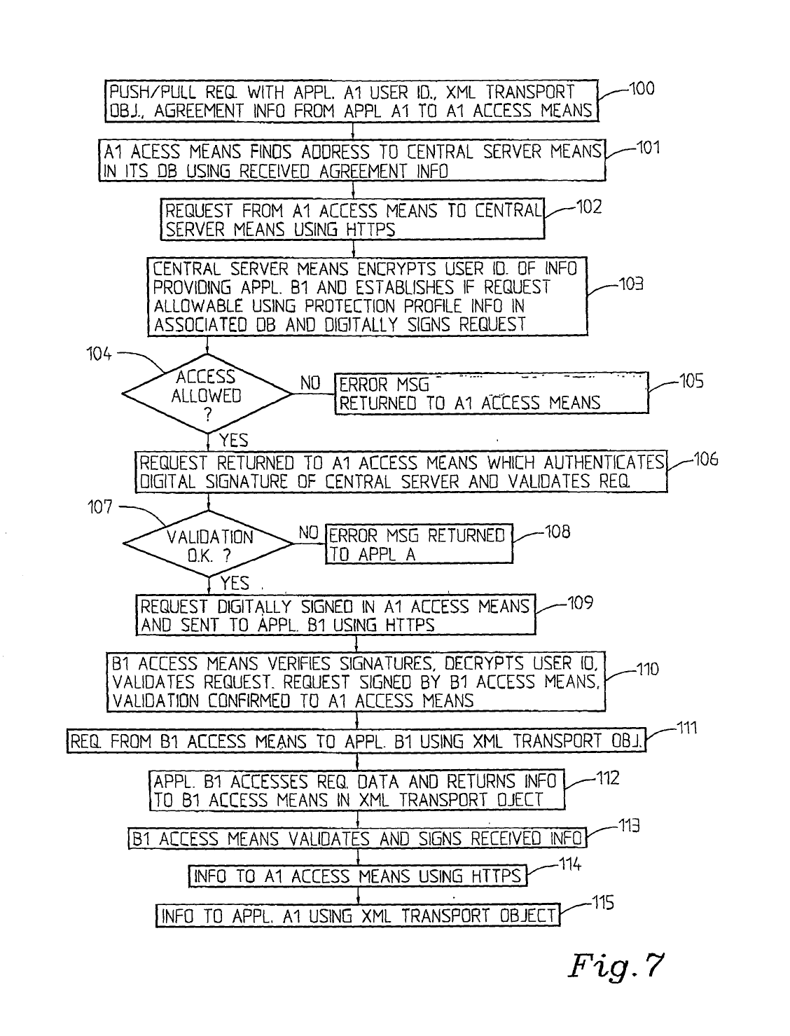

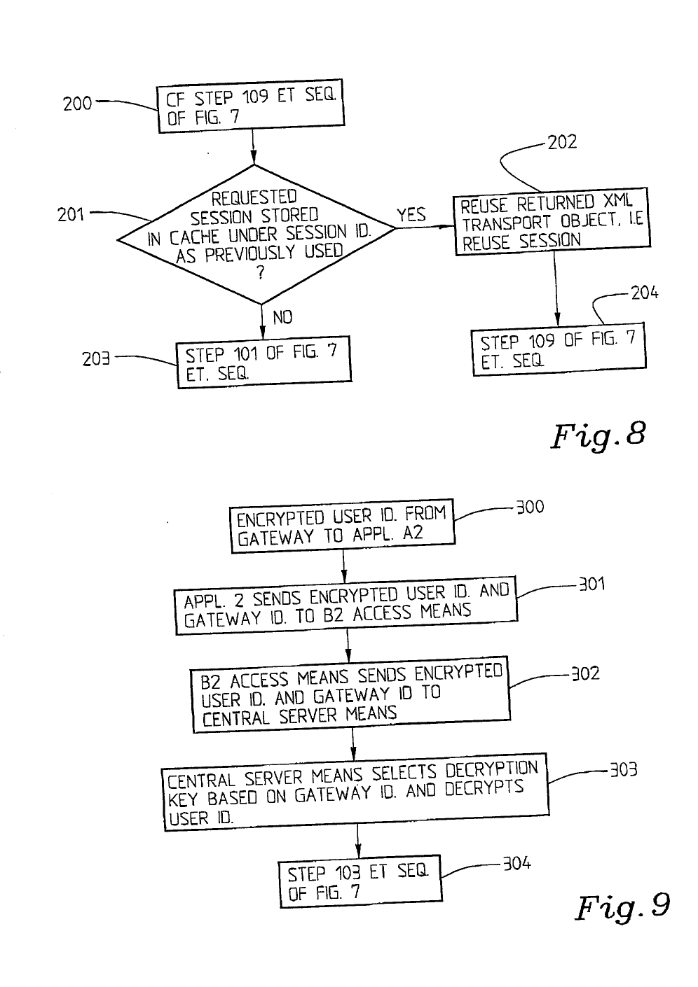

FIG. 7 is a somewhat generalized flow diagram describing the steps of the procedure illustrated with reference to the block diagram of FIG. 4. The requesting application is here denoted A1 and the information providing application is denoted B1.

It is supposed that a push/pull request (i.e. a request to set or get data) with A1 user ID, XML transport object, agreement information etc. is sent from requesting application A1 to A1 access means, 100. A1 does not know who the receiver is, A1 only has knowledge about the relevant agreement. Particularly RMI is used and the request comprises an XML node tree transported in a container.

The access means A1 finds the address to the central server means in its associated database, using the received information about the agreement, which means that it finds the URL in the database to the appropriate central server means. In the database all relevant agreements are contained. A1 access means subsequently signs in band and out of band data, and sends it to the central server means using e.g. HTTPS, 102. The central server means then finds the user ID of the information providing application B1, encrypts the B1 user ID, and examines if the request should be allowed using protection profile information in the associated database, which is signed, and subsequently digitally signs the request (if allowed), 103.

It is thus established if access is allowed, 104. If not, an error message is returned to A1 access means, 105. If however access is granted to all requested data, or to some of the requested data, the request is returned to A1 access means which authenticates the digital signature of the central server and validates the request, 106. If the validation, 107, is not successful, an error message is returned to application A1, 108. If on the other hand, the validation is successful, the request is digitally signed in A1 access means and sent to application B1, using e.g. HTTPS, 109.

In B1 access means the user ID is decrypted, the digital signatures of the access means A1 and of the central server means are verified, and the request is validated. The request is subsequently signed by B1 access means and a confirmation of the validation is provided to the access means A1, 110. The request is also validated towards the database of B1 access means, wherein the relevant agreement is found in the collection of agreements. The signed request is then forwarded from B1 access means to application B1 using an XML transport object over RMI, 111. Application B1 accesses the requested data and returns the requested information to B1 access means in an XML transport object, 112, (data may also be set within the requested personal profile, in an alternative implementation). (If there was no response from the information holding means holding the requested personal profile data in time, an error message is instead returned.) Subsequently the B1 access means validates the XML transport file and signs the information received from application B1, 113. When application B1 accesses the requested data, it is performed e.g. by converting the request to a database call and for example by checking a filled in note or form, or contacts another node/application for information.

B1 access means sends the information, after duly digitally signing it, to A1 access means using HTTPS, 114. The object has then been converted to an XML transport file, and in A1 access means it is converted to an object tree, which is sent to application A1 over RMI using an XML transport object (XML node tree container), 115.

FIG. 8 is a very simplified flow diagram illustrating how a cache can be implemented in association with the respective access means for storing of session related information. The first step, 200, corresponds to step 100 of FIG. 7. Then it is established if the requested session and the session ID of the requested session are stored in the cache as previously used, 201, which in practice means that the access means of B1 has cached the encrypted user ID of application A1. If yes, the returned XML transport object is reused, in other terms, the session is reused, 202. Then it is proceeded with step 109 of FIG. 7 cf. seq., 204. If however there was no session stored in the cache, it is proceeded with step 101 of FIG. 7 etc., 203.

FIG. 9 is a flow diagram schematically illustrating an embodiment in which the requesting application, herein denoted A2, is not trusted, i.e. when the user ID should not be recognized by application A2. The gateway of application A2 then uses an encrypted user ID. In a first step, an encrypted user ID is sent from the gateway to application A2, 300. Optionally the user ID may contain a time stamp to assure that the encrypted ID is different each time A2 is contacted by the gateway. Application A2 sends the encrypted user ID and the gateway ID to the access means of the application A2, 301. A2 access means subsequently sends the encrypted user ID and the gateway ID to the central server means, 302. The central server means selects a decryption key based on gateway ID and decrypts the user ID, 303. It is subsequently proceeded with steps 103 through 115 of FIG. 7, 304.

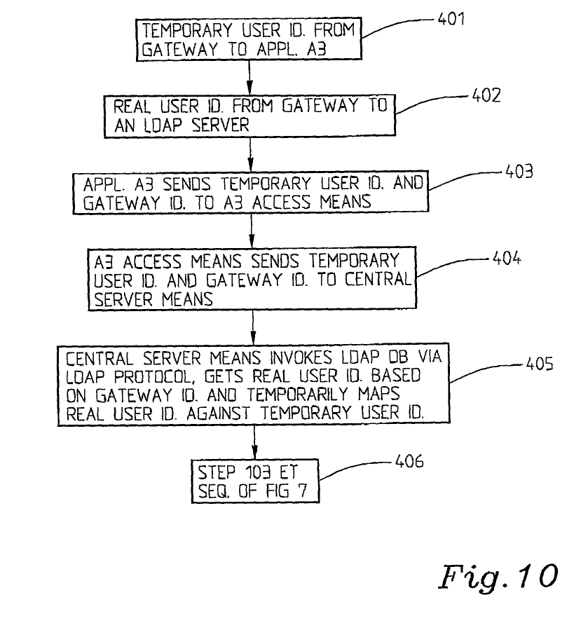

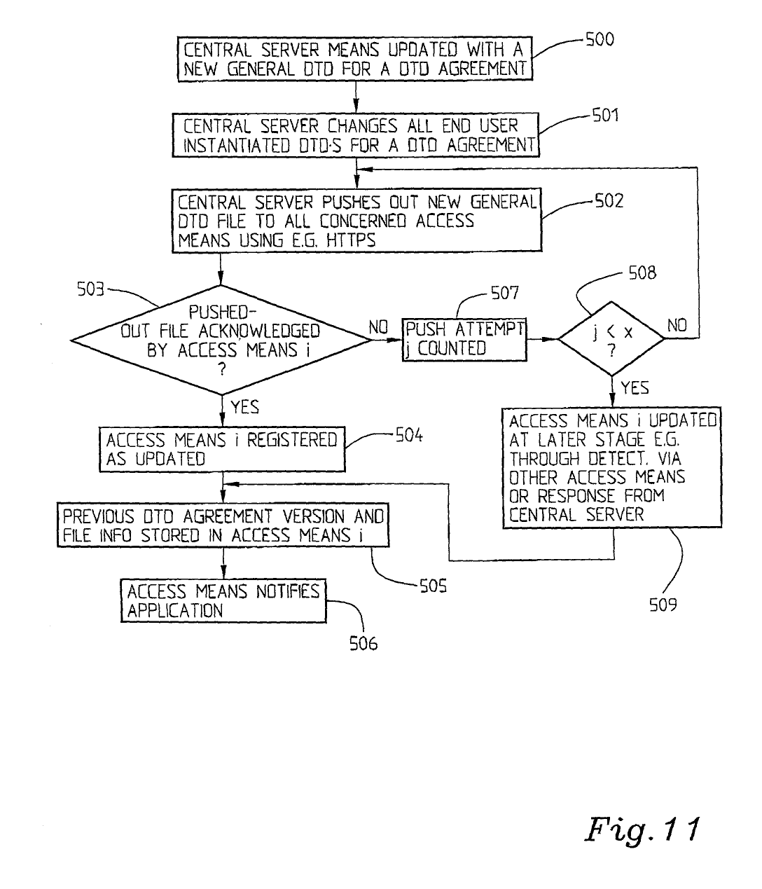

In FIG. 10 an alternative implementation is illustrated for a case when the requesting application A3 is not trusted, and when the user ID should not be recognized by A3. In this implementation the gateway of application A3 uses a temporary user ID. Thus, temporary user ID is sent from the gateway to application A3, 401. The gateway also sends the real user ID to an LDAP (Lightweight Directory Access Protocol) server, 402, with a possibility to map to the temporary user ID. Application A3 sends the temporary user ID and the gateway ID to A3 access means, 403, (c.f. steps 100, 101, 102 of FIG. 7). A3 access means sends the temporary user ID and the gateway ID to the central server means, 404. Thereupon the central server means invokes the LDAP database via the LDAP protocol, gets the real user ID based on gateway ID and temporarily maps the real user ID onto the temporary user ID, 405. The steps III-IX of FIG. 4 then proceed without modification, substantially corresponding to step 103 et. seq. of FIG. 7, 406. Through these implementations support is provided for not trusted applications, such as when an encrypted MSISDN from a WAP (Wireless Application Protocol) gateway, for mobile Internet applications, is used, or when a temporary MSISDN from a WAP gateway towards the application, also for mobile Internet applications, is used.

FIG. 11 illustrates a procedure when the access means are updated by the central server. It particularly relates to making changes to a DTD. It is here supposed that the central server means is updated with a new general DTD for a DTD agreement ID, 500. The central server means updates its database holding personal protection profile data etc. Then the central server changes all end user instantiated DTD:s for the DTD agreement with a given ID, 501. The central server pushes out the new general DTD file (signed) to all concerned access means using e.g. HTTPS, 502. The information contained in the DTD file comprises the general DTD version, DTD agreement ID and the time when the DTD will become valid, signed with the private key of the central server means. It is then established if the pushed out files are acknowledged by access means i, 503. If yes, access means i will be registered as updated, 504. The previous DTD agreement version and file information are stored in access means i, 505, to provide for backwards compatibility. Subsequently access means i notifies the corresponding application to the effect that it has been updated, 506.

It is supposed that a given number, x, of push attempts are allowed, such that if a push j was not acknowledged for access means i, it is examined if push attempt number j is lower than x, 507, 508. If j<x, a new push attempt is tried as from step 502 etc. If however j is equal to x, the access means will be updated at a later stage, e.g. through detection via communication with other access means or by means of a response from the central server, 509. Then it is proceeded with step 505.

Registration of end users can be performed in any appropriate manner.

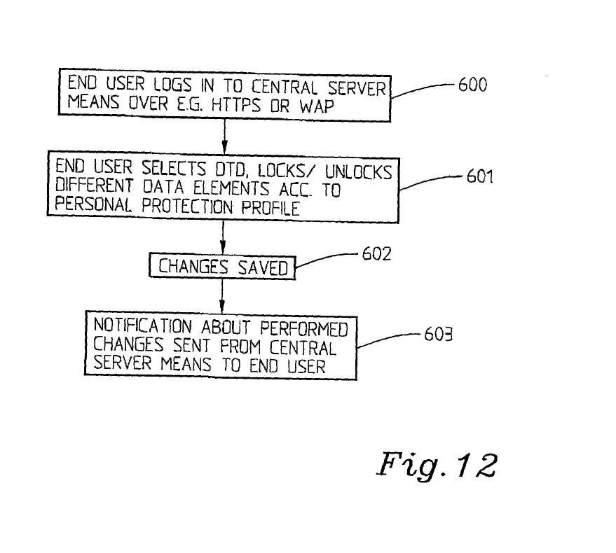

FIG. 12 is a flow diagram illustrating how an end user can control the granting/rejection of access to personal information, i.e. how the end user can control which applications should be granted access or not, and to which data etc.

In the flow diagram of FIG. 12 it is schematically illustrated one example of end user actions that should be performed in order to set a personal protection profile in order to lock and unlock respectively personal information within the personal profiles for different requesters. First it is supposed that the end user logs in to the central server means when connecting to the central server over e.g. HTTPS (it is supposed that the end user is registered in the central server means), 600. Subsequently the end user makes changes or sets up a protection profile by selecting a DTD, locking and unlocking different data elements. If a selection locks the whole DTD, the end user will be notified. This can be done in many different ways, different protection profiles or profile levels may be predefined, or the selection of locked and unlocked data elements etc. may be performed in a more manual way etc. taking legal requirements into account, which advantageously should be provided for automatically. The (new) “protection profile” is then saved, 602. As a confirmation, and if the end user has selected an option to be notified on changes, the central server sends a notification, 603, over SMS (Short Message Service) or as an E-mail to the user. As briefly mentioned above, it is also possible to lock or unlock a complete DTD.

It should be clear that the invention of course not is limited to the specifically illustrated embodiments, but that it can be varied in a number of ways without departing from the scope of the appended claims.

1. A system for end user control of the distribution and maintenance of end user personal profile data in a data communications system providing communication between applications comprising and/or communicating with service/information/content providers or holding means (DB) holding end user personal profile data,
characterized in
that it comprises a personal profile protection network with at least one central protection server means, comprising or communicating with information holding means holding personal protection profile information, and a number of distributed access means, e.g. software modules, whereby for each of said applications at least one access means is provided, and in that grant/reject of an access request for/to end user personal profile data by a requesting application is determined by the central protection server in communication with a requesting application and/or an information providing applications in that translating means are provided for identity translation and that the identity of a requesting application will be concealed for an information providing application, and vice versa.

2. A system according to claim 1,
characterized in
that there is one access means for each application.

3. A system according to claim 1 or 2,
characterized in
that there are a plurality, e.g. a cluster, of access means for at least one application.

4. A system according to claim 1, 2 or 3,
characterized in
that the central server means only comprises personal protection profile data, the personal profile data being distributed throughout the system.

5. A system according to claim 4,
characterized in
that the personal protection profile data comprises information about, for each end user of the system, which of the end user personal profile data that should be accessible by which application(s).

6. A system according to claim 4,
characterized in
that the personal protection profiles are assigned one of a given number of security levels, the lowest level e.g. indicating that for all personal profile data access is prevented for every application, the highest e.g. indicating that all personal profile data is freely available.

7. A system according to any one of the preceding claims, characterized in
that the interface between an application and the respective access means comprises an Application Programmable Interface (API) based on (using) a generic markup language.

8. A system according to claim 7,
characterized in
that the generic markup language is XML.

9. A system according to claim 7 or 8,
characterized in
that access to requested end user personal profile data is granted/rejected by the central server in communication with the requesting application.

10. A system according to claim 7 or 8,
characterized in
that access to requested end user personal profile data is granted/rejected by the central server in communication with the information providing application.

11. A system according to claim 7 or 8,
characterized in
that access to requested end user personal profile data is granted/rejected by the central server in communication with the requesting application and the information providing application.

12. A system according to claim 9, 10 or 11,
characterized in
that first user identity translating means (e.g. encrypting means) are provided at least in the central server means.

13. A system according to claim 10, 11 or 12,
characterized in
that second user identity translating means are provided in the access means of the requesting application.

14. A system according to any one of claims 7-13,
characterized in
that for each pair of applications of the system a general DTD (Document Type Definition) is given to define allowed flow of personal data.

15. A system according to claim 14,
characterized in
that for each user a specific user unique DTD agreement is given.

16. A system according to any one claims 7-15,
characterized in
that an access request for end user profile data is transported from the requesting application to its access means e.g. using RMI, and in that the access request includes a user identity associated with the requested personal end user profile.

17. A system according to claim 16,
characterized in
that the request is transported as an XML transport object (XML Node tree container) tagged with information about the requested end user personal profile data.

18. A system according to claim 16 or 17,
characterized in
that the HTTPS protocol is used for communication between the access means of the requesting/information holding application and the central server means.

19. A system according to any one of the preceding claims,
characterized in
that the access means of the information requesting and/or providing application(s) comprise(s) means for encrypting the user identity associated with the requested end user profile.

20. A system according to any one of the preceding claims,
characterized in
that the request is digitally signed with a private key of the access means of the requesting application and/or with a private key of the access means of the information providing application.

21. A system according to claim 20,
characterized in
that the request is digitally signed with a private key of the central server means, and in that the digital signature(s) of the access means are verified in the central server means.

22. A system according to claim 21,
characterized in
that the central server means comprises means for encrypting at least the user identity associated with the requested information used by the information providing information.

23. A system according to any one of the preceding claims,
characterized in
that at least some of the applications comprise a cache memory respectively for temporarily holding information about access requests, such that a previously used session can be reused, at least for a given time period.

24. A personal profile (privacy) control network for controlling the access to personal profile data,
characterized in
that it comprises at least one central protection server means, comprising or communicating with information holding means holding personal protection profile information, and a number of distributed access means, e.g. software modules, at least one access means respectively interfacing each of a number of applications, the central protection server means comprising means for translating and verifying identities, and in that a request for access to personal profile data by a requesting application is communicated to the requesting application access means and granted/rejected by the central server means in communication with the access means of the requesting application and/or the information providing application, and in that the user identity used by the requesting application is concealed for the information providing application and vice versa.

25. A personal profile control network according to claim 24,
characterized in
that the interface between an application and the respective access means is based on a generic mark-up language.

26. A personal profile control network according to claim 25,
characterized in
that the generic mark-up language is XML.

27. A personal profile control network according to any one of claims 24-26,
characterized in
that the information holding means of the central server means comprises, for each user of the system, a personal protection profile, and in that the personal protection profiles are end user controlled.

28. A personal profile control network according to claim 27,
characterized in
that the central server means and at least one of the information requesting/providing access means digitally sign a request for personal profile data with the respective private key, and in that the digital signatures are verified by the central server means.

29. A method of controlling access to personal data within a personal end user profile in a data communication network running a number of applications comprising or communicating with information holding means,
characterized in
that it comprises the steps of:
providing an access request from a requesting application to an access means associated with the requesting application using a generic mark-up language, e.g. XML,
forwarding the request from the access means to a central server means with information holding means holding personal protection profiles for the end users in the system;
performing user identification encryption, such that the user identification of the requesting application will be concealed from an information providing application, and vice versa;
establishing, by using the request and the personal protection profile whether access is to be granted or denied;
if access to the requested personal profile is to be granted,
confirming to the access means of the requesting application whether access is to be granted or not, preferably after digitally signing the request;
allowing transfer of the encrypted and preferably digitally signed request to the information providing application.

30. The method according to claim 29,
characterized in
that the request of a requesting application relates to getting access to data/fetching data in a personal profile and in that, for a granted request, the method comprises the step of:
transferring the requested data via the access means of an information providing application over a data communication network, e.g. Internet, to the access means of the requesting application.

31. The method according to claim 29,
characterized in
that the request of a requesting application relates to setting/updating data in a personal profile, and in that, for a granted request the method further comprises the step of:
transferring the data to be set/updated data to the information providing application over the data communication network.

32. A method of controlling access to personal data within a personal end user profile in a data communication network running a number of applications comprising, or communicating, with information holding means,
characterized in
that it comprises the steps of:
forwarding a request for access to data within a personal profile from a requesting application via at least one distributed access means to a central server means;
establishing in the central server means whether access to requested data should be allowed or not by comparing the request with an end user controlled personal protection profile;
providing the at least one distributed access means with information as to whether access is allowable or not, such that if access is allowable, the data communication network can be used for giving the requesting application access to the requested data without the identity of the requesting application being visible to the application able to provide access to the requested data, and vice versa.

33. A method according to claim 32,
characterized in
that it further comprises the steps of:
encrypting a user identity associated with the requested end user profile into the request at the central server means or at access means associated with the requesting application;
decrypting the user identity at access means associated with the information providing application.

34. The method according to claim 32 or 33,
characterized in
that it comprises the steps of:
digitally signing the request at one or more of the access means associated with the information requesting application, the access means associated with the information providing application and the central server means, said access means and the central server means constituting a personal profile data protection network.
